(19) United States
(12) Patent Application Publication
(10) Pub. No.: US 2007/0166024 A1
(43) Pub. Date: Jul. 19, 2007

(54) Camera and footwear

(75) Inventor: Rodney H. Robinson, Los Angeles, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(73) Assignee: ACI International

(21) Appl. No.: 11/336,469

(22) Filed: Jan. 19, 2006

(51) Int. Cl. G03B 19/00

(52) U.S. Cl. 396/429

(57) ABSTRACT

Footwear includes an outer sole and an upper and a body between the upper and the sole. Within that body there is a camera unit and part of the camera is mounted on the outer sole. The sole can have different portions, namely, one or more sole portions. In the one or more sole portions, there is room to accommodate a view screen associated with the camera. The screen can be located towards the toe portion of the footwear. A lens can be located in the toe portion of the footwear and as such may extend through the material, which is upwardly directed from the sole. There can be a flap of material to cover the lens.

### BACKGROUND OF THE DISCLOSURE

1. Field of the Disclosure

This disclosure relates to a camera or other entertainment device in the form of footwear. A camera and entertainment device is associated with a footwear item in the form of a shoe or boot.

Many forms of cameras such as digital still or movie cameras are known. In addition, many different forms of footwear shoe and boots are known.

There is a need for a different form of camera and footwear, which is in the sense of an entertainment unit, and this disclosure is directed to meeting that need.

### SUMMARY

The present disclosure relates to a footwear unit which includes a camera. In particular, it concerns a footwear element, which is useful as a camera. Such footwear is not normally associated with cameras. Further, such footwear in the form of a shoe, boot or the like which is normally an article to be worn by a user is the subject of the present disclosure.

According to the disclosure, the footwear includes an outer sole, an upper, and a body between the upper and the sole. Within that, body there is a camera unit and part of the camera is mounted on the outer sole. The sole can have different portions, namely, one or more sole portions. In the one or more sole portions, there is room to accommodate a view screen associated with the camera. The screen can be located towards the toe portion of the footwear. A lens can be located in the toe portion of the footwear and as such may extend through the material, which is upwardly directed from the sole. There can be a flap of material to cover the lens.

The sole can be made of the normal plastic or rubberized material for normal footwear. Similarly the upper material is formed from the normal upper material which can be a leather other natural or synthetic material. As such, the footwear is a relatively natural looking shoe or boot and is sized to be large enough to fit on the foot of a user.

In a particularly attractive and useful form of the device, the footwear is an athletic shoe and is sized for the normal footwear of an adult sports player. As such, it can for instance be the size of an adult basketball player, and therefore can be for a relatively large adult.

The camera can include the mechanisms for recording pictures digitally and outlets can permit for MP3 and/or TV receiver connections.

As such, the disclosure is directed to a footwear element, which is camera, such that the footwear element in the form of a virtual shoe can be used as a camera. A door in the sole portion can be used to mount the screen. Opening the door can provide access to the screen and other controls of the camera. The door is hinged to other parts of the sole.

While the disclosure is susceptible to more embodiments made in different forms, there is shown in the accompanying drawings a description of a detailed specific embodiment whether it should be understood that the present disclosure is to be considered an exemplification of the principles of the invention and is not intended to be limited of the invention.

### BRIEF DESCRIPTION OF THE DRAWINGS

FIG. 1 is a perspective view of the underneath of an athletic shoe from the front illustrating the lens and an open portion of the sole of the shoe.

FIG. 2 is a perspective view of the top of an athletic shoe from the front illustrating the lens and an open portion of the sole of the shoe.

FIG. 3 is a perspective view of the underneath of an athletic shoe from the back illustrating the open portion of the sole of the shoe

FIG. 4 is a perspective view of a second embodiment of the underneath of an athletic shoe from the front illustrating the lens and an open portion of the sole of the shoe.

FIG. 5 is a perspective view of the second embodiment of the top of an athletic shoe from the front illustrating the lens and an open portion of the sole of the shoe.

FIG. 6 is a perspective view of the second embodiment of the underneath of an athletic shoe from the back illustrating the open portion of the sole of the shoe.

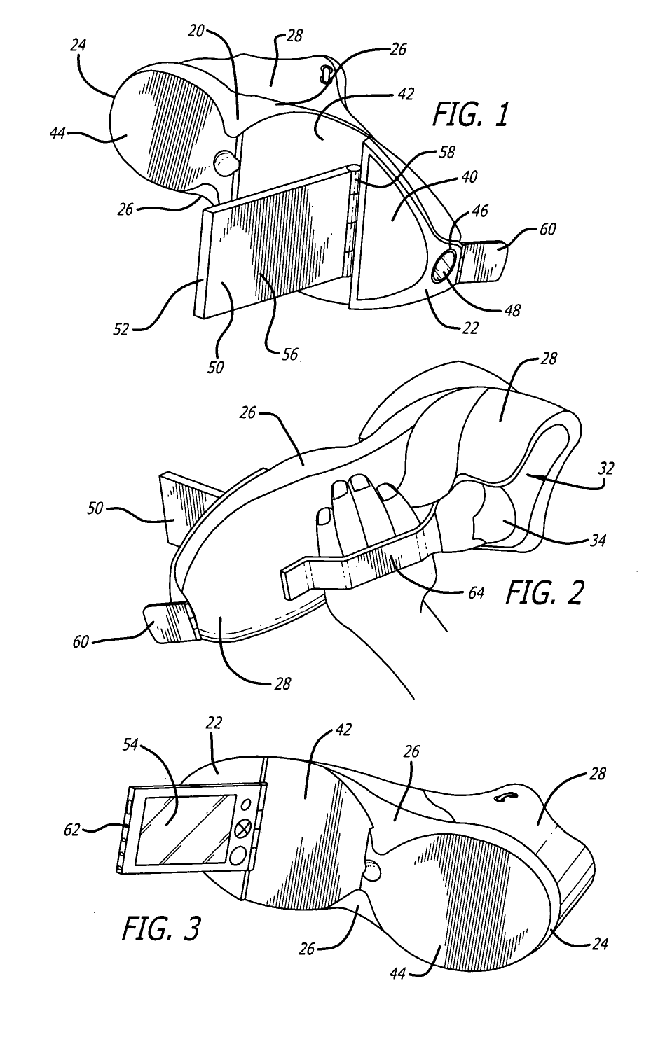

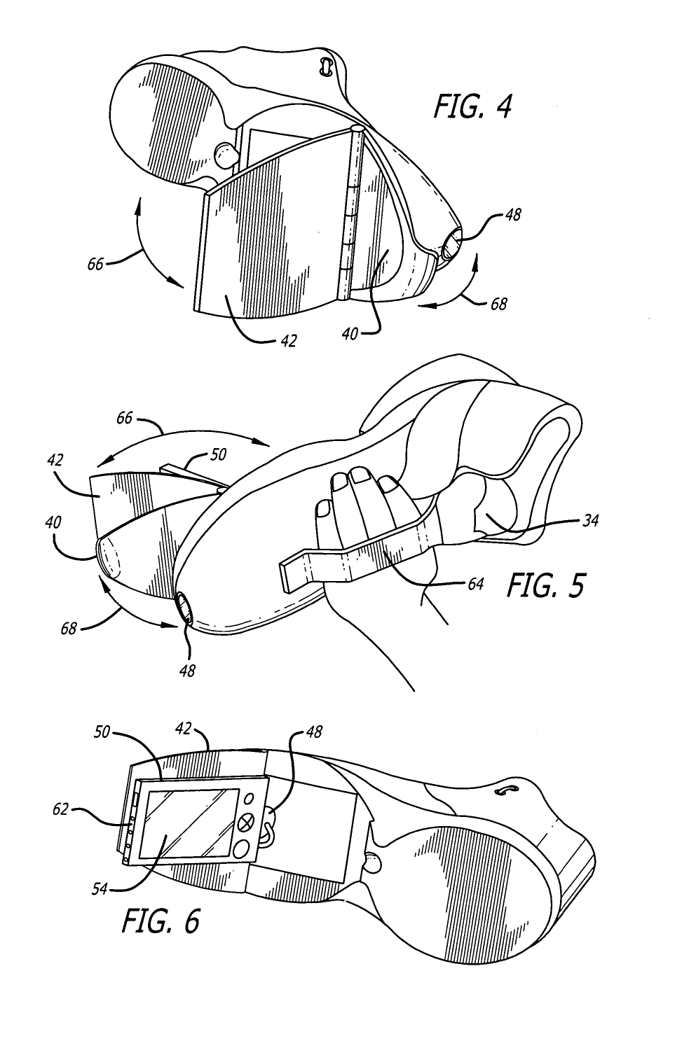

### DETAILED DESCRIPTION OF THE DRAWINGS

A camera and footwear unit comprises an outer sole and an upper. There is a camera, and the camera includes a casing, and a movable view screen relative to the casing and a lens. The outer sole and upper forms a body between the upper and the sole and within that body there is mounted the camera and wherein at least part of the camera is mounted on the outer sole. The sole includes more than one sole portion, and in one of the sole portions, there is accommodation of the view screen associated with the camera. The sole portion is movable thereby to house the screen on a face portion of the sole directed internally towards the body of the shoe.

Preferably, the screen is located towards the toe portion of the footwear, the screen being mounted on a hinged portion of the outer sole and being on a face portion of the sole directed internally towards the body of the shoe. The lens is located in the toe portion of the footwear and selectively may extend at least partly through material that is upwardly directed from the sole. As such, the lens can be located in the upper at the toe portion of the footwear, the upper including a hole. There can be a flap of material to selectively cover the lens.

The sole is made of the normal plastic or rubberized material for normal footwear. The upper material is formed from the normal upper material which can be a leather other natural or synthetic material. The footwear is a relatively natural looking shoe or boot and is sized to be large enough to fit on the foot of a user.

The camera can include mechanisms for recording pictures digitally and selectively an outlet for at least one of an MP3 player or a TV receiver.

There can be a door in the sole portion for mounting a screen of the camera, and wherein opening the door provides access to the screen, and the door can be hinged to another portion of the sole.

The arrangement includes a handle located over the area for normal location of a tongue. The handle extends above the normal location for the tongue, and extending longitudinally in line with a longitudinal direction of the shoe.

As such, the camera containing footwear unit comprises an outer sole and an upper. The outer sole is dissected into the sections, including from the toe towards the heel at least a sole portion, a transverse non-sole material space, and a rear sole portion. There is a transverse axle structure for supporting spaced apart wheels accommodated in the transverse spaced portion of the sole. Part of the upper and part of the outer sole are cut away relative to normal footwear thereby to permit the location of camera components.

The camera mechanism is located essentially in the body of the shoe between the outer sole and the below the upper. The camera mechanism is located essentially in the body of the shoe between the outer sole and the below the upper. There is no superstructure above the body of the footwear. The outer sole is formed by material normal for normal footwear and the upper is formed by material for an upper for normal footwear.

An amusement device in the form of a camera footwear unit includes an outer sole 20, which includes a toe portion 22 and a heel portion 24. There are two side portions 26, which extend between the toe 22 and heel 24. Above the outer sole 20 there is an upper 28, which is formed by two sections, which are normally connected through a laced up portion with a lace. Between the top of the outer sole 20 and the underneath of the upper 28, there is a body portion 32, which is the interior portion of the footwear. There can also be a conventional tongue 34. Pulling the tongue 34 out can provide relatively easy access to the interior body portion of the shoe. The sole 20 includes more than one sole portion, namely portions 40, 42 and 44.

The upper 28 includes a cut away hole or area 46 towards the toe 22 of the shoe so that a lens 48 can extend from the toe area or be accommodated there to permit for access for the camera lens 48 at least partly ahead of the toe. There can be a flap of material 60 to selectively cover the lens 48.

A camera 50 with a casing 52 is mounted on the sole 20. At least part of the camera 50, namely the screen portion 54 is mounted to face the outer sole 20. The view screen 54 associated with the camera 50 is mounted on the inside of the casing and is a hinged feature under the sole portion 42. A portion 56 of the sole portion 42 is movable thereby to house the screen 54 which is itself connected to and moveable relative to the camera lens construction in the body 32 of the shoe.

The screen 54 is located towards the toe portion 22 of the footwear and the screen 54 is mounted on a hinged structure 58 of the outer sole 20.

The sole 20 is made of the normal plastic or rubberized material for normal footwear. The upper material is formed from the normal upper material which can be a leather other natural or synthetic material. The footwear is a relatively natural looking shoe or boot and is sized to be large enough to fit on the foot of a user.

The camera 50 can include mechanisms for recording pictures as still or movie pictures digitally and selectively there are outlets 62 for an MP3 player and/or a TV receiver.

The arrangement includes a handle 64 located over the area for normal location of a tongue 34. The handle 64 extends above the location for the tongue 34, and extending longitudinally in line with a longitudinal direction of the shoe.

In a second embodiment, the forward part 40 of the sole 20 is formed of a hinged component. The forward part 40 is hinged so that the front of the forward part can be a cover for the front of the lens 48. The arrow 68 shows the movement of the front portion 40. The arrow 66 shows the movement of the mid portion 42.

As such, the camera containing footwear unit comprises an outer sole and an upper. The outer sole is formed in sections including a portion adjacent to the toe a portion towards the heel, and a centralized sole portion. Part of the upper and part of the outer sole are cut away relative to normal footwear thereby to permit the location of camera components.

The camera mechanism is located essentially in the body of the shoe between the outer sole and the below the upper. There is no superstructure above the body of the footwear. The outer sole is formed by material normal for normal footwear and the upper is formed by material for an upper for normal footwear.

Many other forms of the invention exist, each different from the other in matters of detail only.

In some other aspects of the disclosure there can be multiple shoes, which are using one or more camera footwear units, which can be entertaining to an audience of a game.

For instance, there can be shoes sized and colored to reflect competing players and teams, and can be used as at least part an entertainment medium and system. The shoes or footwear units have nothing else related to the human body associated with them. As such, there is no other replication of other limbs of a human body, such as the legs, feet or other parts of the body torso.

Although certain illustrative embodiments and methods have been disclosed herein, it will be apparent form the foregoing disclosure to those skilled in the art that variations and modifications of such embodiments and methods may be made without departing from the true spirit and scope of the art disclosed. Many other examples of the art disclosed exist, each differing from others in matters of detail only. Accordingly, it is intended that the art disclosed shall be limited only to the extent required by the appended claims and the rules and principles of applicable law.

I claim/We claim:

1. A camera and footwear unit comprising:
an outer sole and an upper;
a camera, the camera including a casing, a movable view screen relative to the casing and a lens; and
the outer sole and upper forming a body between the upper and the sole, and within that body there is mounted the camera and wherein at least part of the camera is mounted on the outer sole.

2. A camera and footwear unit as claimed in claim 1 wherein the sole includes more than one sole portion, and wherein with one of the sole portions there is accommodation of the view screen associated with the camera, the sole portion being movable thereby to house the screen on a face portion of the sole directed internally towards the body of the shoe.

3. A camera and footwear unit as claimed in claim 1 wherein the sole includes different portions, and wherein in one of the sole portions there is an accommodation of the view screen associated with the camera.

4. A camera and footwear unit as claimed in claim 1 wherein the screen is located towards the toe portion of the footwear, the screen being mounted on a hinged portion of the outer sole and being on a face portion of the sole directed internally towards the body of the shoe.

5. A camera and footwear unit as claimed in claim 1 wherein the lens is located in the toe portion of the footwear and selectively may extend at least partly through material which is upwardly directed from the sole.

6. A camera and footwear unit as claimed in claim 1 wherein the lens is located towards the toe portion of the footwear and the outer sole includes a hinged portion, the hinged portion being for movement between a position overlying the lens and a position removed from the lens.

7. A camera and footwear unit as claimed in claim 1 wherein the lens is located in the upper at the toe portion of the footwear, the upper including a hole.

8. A camera and footwear unit as claimed in claim 1 including a flap of material to selectively cover the lens.

9. A camera and footwear unit as claimed in claim 1 wherein the sole is made of the normal plastic or rubberized material for normal footwear.

10. A camera and footwear unit as claimed in claim 1 wherein the upper material is formed from the normal upper material, which can be a leather, other natural or synthetic material.

11. A camera and footwear unit as claimed in claim 1 wherein the footwear is a relatively natural looking shoe or boot and is sized to be large enough to fit on the foot of a user.

12. A camera and footwear unit as claimed in claim 1 wherein the camera includes mechanisms for recording pictures digitally and selectively an outlet for at least one of an MP3 player or a TV receiver.

13. A camera and footwear unit as claimed in claim 1 including a door in the sole portion for mounting a screen of the camera, and wherein opening the door provides access to the screen, and wherein the door is hinged to another portion of the sole.

14. A camera and footwear unit as claimed in claim 1 including a handle located over the area for normal location of a tongue, the handle extending above the normal location for the tongue, and extending longitudinally in line with a longitudinal direction of the shoe.

15. A camera and footwear unit comprising:
an outer sole and an upper;
a camera, the camera including a casing, a movable view screen relative to the casing and a lens;
the outer sole and upper forming a body between the upper and the sole, and within that body there is mounted the camera, and wherein at least part of the camera is mounted on the outer sole;
the lens being located in the toe portion of the footwear and selectively extendable at least partly through material which is upwardly directed from the sole; and
the sole includes different portions, and wherein a sole portion provides a mounting for the view screen associated with the camera.

16. A camera and footwear unit as claimed in claim 15 wherein the screen is located towards the toe portion of the footwear.

17. A camera and footwear unit as claimed in claim 15 including a flap of material to cover the lens.

18. A camera and footwear unit as claimed in claim 15 including a door in the sole portion for mounting a screen of the camera, and wherein opening the door provides access to the screen, and wherein the door is hinged to another portion of the sole.

19. A camera and footwear unit as claimed in claim 15 including a handle located over the area for normal location of a tongue, the handle extending above the normal location for the tongue, and extending longitudinally in line with a longitudinal direction of the shoe.
